(19) United States
(12) Patent Application Publication
(10) Pub. No.: US 2020/0030169 A1
(43) Pub. Date: Jan. 30, 2020

(54) Emergency Medical Services Lifting Device

(71) Applicants: Paul John KRINJAK, Orange City, FL (US); Michael R. Pinkin, Manchester, CT (US)

(72) Inventor: Paul John Krinjak, Orange City, FL (US)

(21) Appl. No.: 16/491,199

(22) PCT Filed: Mar. 6, 2018
(86) PCT No.: PCT/US18/21127

§ 371 Date: Sep. 5, 2019

Related U.S. Application Data
(60) Provisional application No. 62/467,537, filed on Mar. 6, 2017.

(51) Int. Cl. A61G 7/10; B66F 9/02

(52) U.S. Cl. CPC A61G 7/1019; B66F 9/02; A61G 7/1057; A61G 7/1015

(57) ABSTRACT

A lifting device including a body, at least a first support member and a second support member associated with the body, a power source, a platform movable relative to the body between a first position and a second position, wherein the lifting device is configured to receive an object on the platform, and to raise or lower the object between the first position and the second position; and a platform lifting mechanism associated with the platform, configured to lift and lower the platform so as to lift and lower a subject thereon.

### BACKGROUND

In the Emergency Medical Services (EMS) world, lifting injured or uninjured subjects can be a daily occurrence. In some cases, the weight of these subjects may be far greater than the lifting capacity of one or multiple EMS personnel. Furthermore, it is important that devices used for lifting subjects be designed to be easily loaded and unloaded from an EMS truck, for example, and easily transported to and from the location of the fallen subject to be lifted, as well as easily operated to lift a heavily weighted subject without injuring the personnel responsible for the lifting.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1A is a block diagram that illustrates an example lifting device according to an embodiment.

FIG. 1B is a perspective view of a lifting device according to another embodiment.

FIG. 2 is a side view of a lifting device according to an embodiment, demonstrating a collapsed position.

FIG. 3A is a side view of a lifting device according to an embodiment.

FIG. 3B is a top view of the embodiment of the lifting device of FIG. 3A.

FIG. 3C is a rear view of the lifting device embodiment shown in FIG. 3A.

FIG. 4 is a rear perspective view of a lifting device embodiment, with a platform in a first position.

FIG. 5 is a side perspective view of an embodiment of a lifting device, with a platform shown in a first, lowered position.

FIG. 6 is a side perspective view of an embodiment of a lifting device with a platform shown in a raised position.

FIG. 7 is a side perspective view of an embodiment of a lifting device with a platform shown in a raised position.

### DESCRIPTION

For the purposes of promoting an understanding of the principles and operation of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to those skilled in the art to which the invention pertains.

The terminology used herein is for the purpose of describing particular embodiments only and is not intended to be limiting. As used herein, the singular forms “a,” “an,” and “the” are intended to include the plural forms as well, unless the context clearly indicates otherwise these terms do not denote a limitation of quantity, but rather denote the presence of at least one of the referenced item. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order, quantity or importance, but rather the terms first, second, etc., are used to distinguish one element from another. The modifier “about” used in connection with a quantity is inclusive of the stated value and has the meaning dictated by the context (e.g., includes the degree of error associated with measurement of the particular quantity). It is to be noted that all ranges disclosed within this specification are inclusive and are independently combinable.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. As a non-limiting example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 7.

As used herein, the terms “subject”, and “object” are used interchangeably. As used herein, the term “subject” refers to an animal, preferably a mammal such as a non-primate (e.g., cows, pigs, horses, cats, dogs, rats etc.) and a primate (e.g., monkey and human), and most preferably a human. Furthermore, the terms “subject” and “object” are used interchangeably herein, as the device 100 may be used to raise one or more objects. For example, the device 100 may be used to raise objects from the floor to an elevated position. The device 100 may be used to manipulate heavier objects, and to remove them from the floor, or to place an object onto the floor without having to bend over, in an example.

The term “associated” or “association”, as used herein, includes but is not limited to direct and indirect attachment, adjacent to, in contact with, partially or fully attached to, and/or in close proximity therewith.

The inventors herein have designed a lifting device for raising a subject. In an example, the subject may be raised from the ground to a seated position, to enable mobility of the subject with or without the assistance of emergency personnel. The design further contemplates the importance of ease of movement of the device into and out of the location in which the subject is located, as well as the transportability of the device on a truck, or other vehicle.

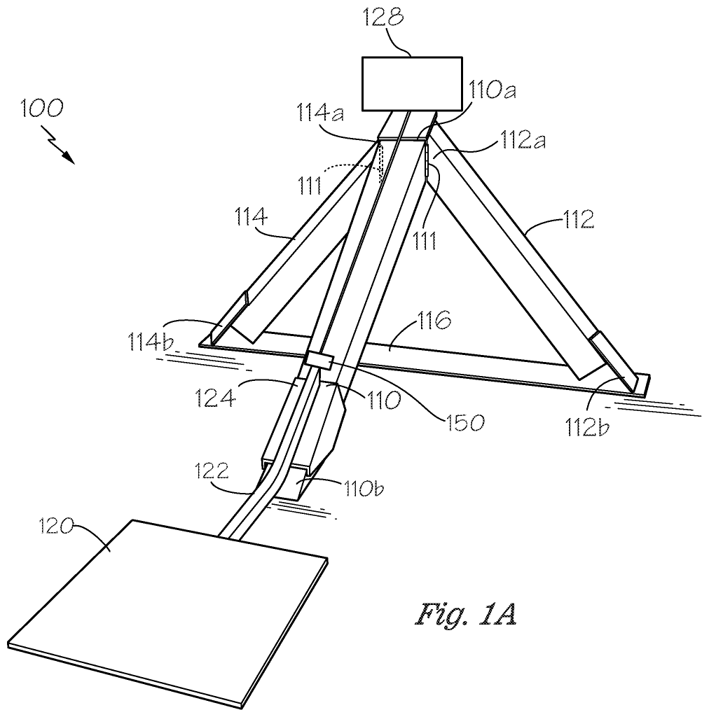

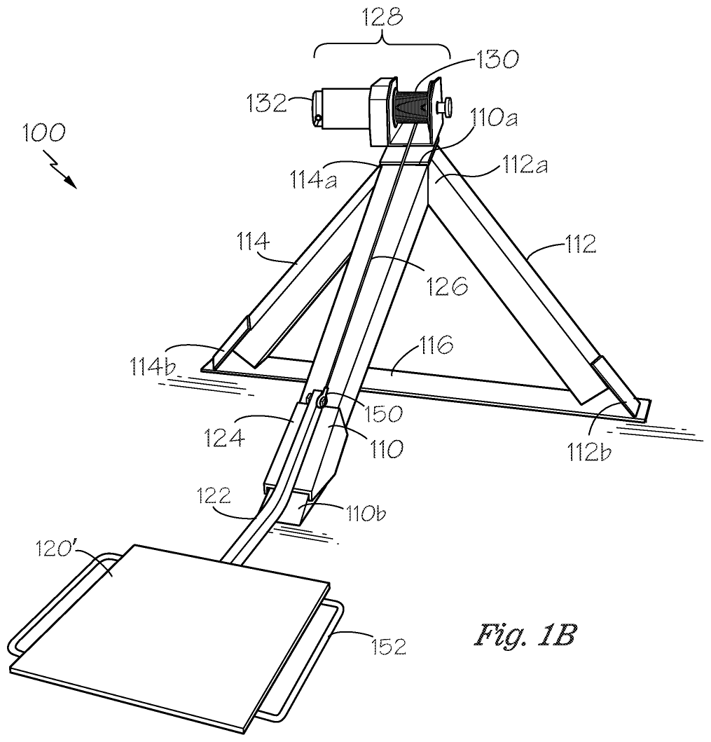

A block diagram illustrating an example lifting device 100 according to an embodiment is provided in FIG. 1A for lifting an object. The lifting device may include a body and a plurality of support members for supporting the body when placed on a generally horizontal surface (i.e., a floor or ground). In the illustrated embodiment of FIG. 1A, the lifting device 100 includes a body 110 having a first end 110a and a second end 110b. The body second end 110b being configured to associate with a generally horizontal surface, and the body first end 110a being configured to associate with at least a first support member 112 and a second support member 114. Additional support members may be provided in some embodiments. The first and second support members 112, 114 each include a first end 112a, 114a for associating with the first end of the body 110a, and a second end 112b, 114b for associating with a generally horizontal surface, either directly or indirectly. The positioning of the support members relative to the body 110 provides support for lifting objects on the platform of significant weight, while maintaining the upright position of the device. Due to the displacement of the weight of the object being lifted on the platform amongst the body and the support members, heavy objects can be safely lifted by the platform.

The first and second support members second ends 112b, 114b may associate indirectly with the generally horizontal surface via a support base member 116. The support base member 116 may span from the second end of the first support member 112b to the second end of the second support member 114b to provide additional support for the device 100. The support base member 116 may take on many different shapes and sizes, with the overall function of providing additional support to the device via the support members 112, 114 and the body 110. In some embodiments, the support base member 116 is removable from the device 100. The second ends of the support members 112b, 114b may attach to the support base member 116 by any means known in the art, by friction fit, or wherein the base member 116 includes an opening for a portion or an extension of the second end of the support members 112b, 114b to fit within, to adjoin, removably or in some instances permanently, the support members 112, 114 to the support base member 116. The support base member 116 is optional, and in some embodiments, the first and second support members 112, 114 may include a wider portion at their respective second ends 112b, 114b to associate with the generally horizontal surface (or with the support base member) and to provide additional support to the device 110.

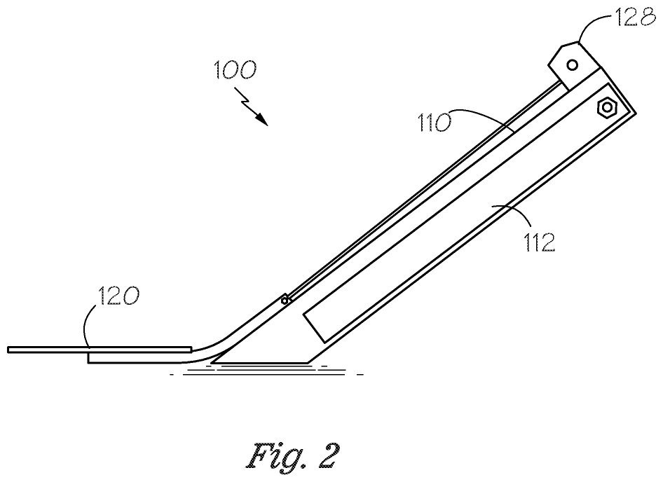

The first ends of the body 110a, the first support member 112a and the second support member 114a may be directly connected or indirectly connected to one another. The support members 112, 114 may be connected to the body 110 by way of a coupling mechanism 111, in non-limiting embodiments. In some embodiments, the coupling mechanism 111 may include a hinge mechanism as shown in FIG. 1A, in a non-limiting embodiment, which allows rotational movement at the intersection between the first support member 112 and the body 110, and the second support member 114 and the body 110. In this embodiment, the device 100 may be collapsible (as shown, for example, in FIG. 2) for efficient loading and unloading, and for easy movement of the device 100. In some embodiments, collapsing of the body 110 and the first and second support members 112, 114, for ease of movement of the device 100 may occur by way of the coupling mechanism, embodied as hinge members 111, in the illustrated embodiment. Other means known in the art for attaching the first and second support members 112, 114, to the body 110, allowing collapsibility of the members 112, 114 may be used in place of hinge members 111. In some embodiments, the base member 116 may not be included. In some embodiments, the base member 116 may be removable from the device 100. In some embodiments described herein, the support members 112, 114 may rotate in toward the body 110, and in some embodiments the support members may be secured alongside the body 110 along its longitudinal axis, in general alignment with the body 110, to facilitate efficient transportation of the device 100.

The device 100 may further include a platform 120 directly or indirectly associated with the body 110, and slidable relative to the body 110 for raising or lowering an object on the lifting device 100. The platform 120 may be removably attached to a portion of the body 110. In some embodiments, the platform 120 may be attached to a portion of the body 110, or to a portion of a platform lifting mechanism 128 of the device 100 by way of a connection mechanism 150. The connection mechanism 150 may include a quick connect mechanism allowing for rapid removal and re-attachment of the platform 120 onto the device 100, in one example. In one non-limiting embodiment, the quick connect mechanism 150 may include a hook at the end of a cable 126 (which may alternatively be embodied as a chain), which is associated with the platform lifting mechanism 128 to lift the platform 120 by way of retraction or winding of the cable 126 (or chain) and a hook receiving portion on a portion of the platform 120 or a lifting arm 122 attached thereto, in a non-limiting embodiment.

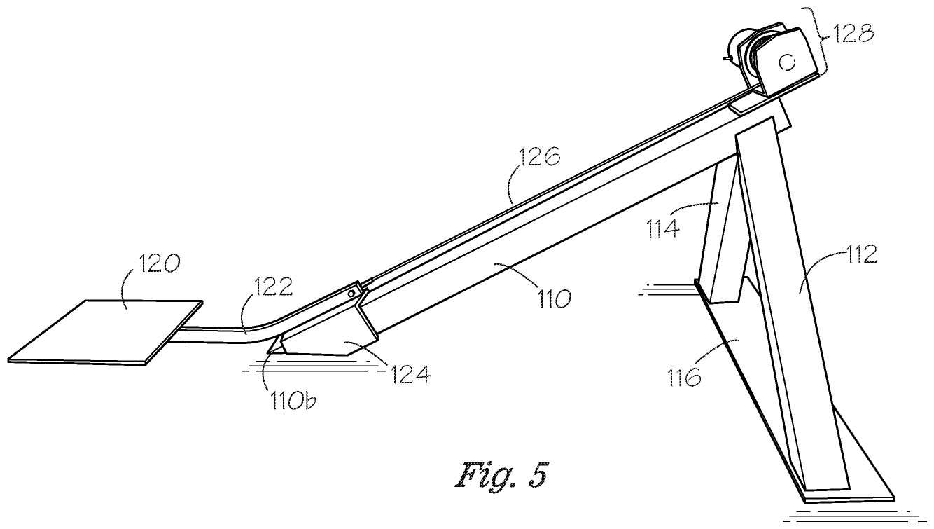

In some embodiments, the platform 120 may be in direct contact with the body 110. In another embodiment, as shown in FIG. 1A, the platform 120 may be in indirect contact with the body 110 via the lifting arm 122 and a lifting arm bracket 124 as shown in FIG. 1A. The lifting arm bracket 124 slides relative to the body 110, by way of attachment to the platform lifting mechanism 128 to facilitate lifting and lowering of a subject or object on the platform 120. The lifting arm 122 is associated with the lifting arm bracket 124, which is associated with the platform 120 to slide the platform 120 relative to the body 110 as shown in FIGS. 5-7. Consequently, movement of the lifting arm bracket 124 relative to the body 110 moves the platform 120 relative to the body 110. This movement raises or lowers the platform 120 and any objects placed thereon.

In FIG. 1B, the device is shown 100, wherein the platform 120′ is provided on or near the generally horizontal surface (i.e., the floor) in a first position. This first position may be used to load a subject onto the platform 120′ to be lifted by the lifting device 100 when the subject has fallen and cannot get up from the floor alone or with the assistance of another, in a non-limiting embodiment. In this example, the subject would be moved, or would move him or herself onto the platform 120′ by sliding or lifting slightly to place his/herself onto the platform 120′, or with assistance from the operator of the device 100, at which point the lifting device would be operated to raise the platform 120′ from the first position to another position so as to assist in picking the subject up from the floor and placing the subject in a sitting or standing position, for example. In some embodiments, one or more handles 152 may be used to move the platform 120′, which may be removable from the device 100, to place the platform 120′ beneath a subject. In some instances, a subject may fall in an area where it may be difficult to get access to the subject. Consequently, a removable platform 120′ may be placed near the subject, and once the subject is placed on the platform 120′, the platform 120′ may be connected to the platform lifting mechanism 128. In some embodiments, the platform 120, 120′ may include or more wheels, allowing the platform 120, 120′ to be easily movable to the device 100, once removed, and once a subject is placed thereon.

In cases of emergency situations where a subject has fallen and cannot get up, the emergency personnel assisting the subject may use the device 100 to lift the subject from the floor into a sitting position, such that the subject's legs can help support the subject to stand. In another embodiment, the lifting device 100 can be used to lift the subject to a sitting position, for example, such that the subject can be loaded into a wheelchair, or bed, or another device or location.

In one non-limiting embodiment, the platform lifting mechanism 128 may include a winch, wherein a first end of a cable 126 is attached to the lifting arm bracket 124 or the lifting arm 122, or the platform 120, and a second end of the cable 126 is attached to, and wound around a portion of a winch. The winch may include a spool 130 and a powering component 132. The second end of the cable 126 may be wound around the spool 130 of the winch, and winding of the cable 126 around the spool 130 may be used to raise and/or lower the platform 120 via the cable 126. The cable 126 is disposed, in one non-limiting embodiment, along the longitudinal axis of the body 110 of the device 100.

The powering component 132 may include an electric, hydraulic, pneumatic, or internal combustion drive, a solenoid brake and/or mechanical brake, or a ratchet and pawl device to prevent the spool from unwinding unless the pawl is retracted, in some non-limiting embodiments. As mentioned herein, the device 100 may include a hydraulic lifting mechanism, in a non-limiting embodiment.

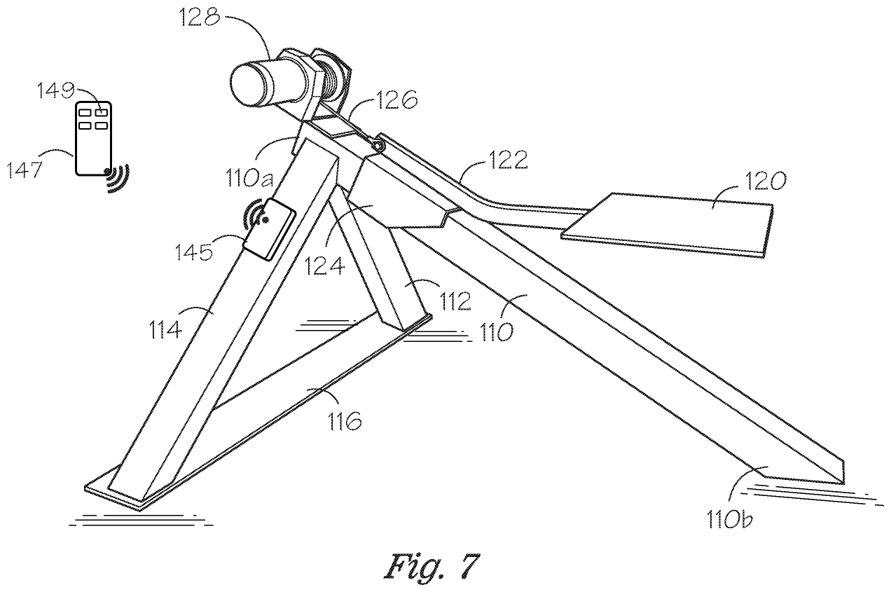

In some embodiments, the device may include a controller 145 as shown in FIG. 7 configured to receive input from a user, to control the platform lifting mechanism 128, and initiate or terminate lifting and lowering of the platform 120, 120′. The controller may include a processor and wireless connection means in some embodiments. In some embodiments, the controller 145 may be wirelessly operated by way of a remote 147. In some embodiments, the remote may include one or more input receiving members 149, which may be mechanical or digital, for example, and configured to receive input from a user to control the platform lifting mechanism 128 to lift or lower the platform 120. The remote 147 may be associated with the controller 145 by wired or wireless connection, such as Bluetooth® or other wireless means. The controller 145, therefore, may be offboard of the device 100. In other embodiments, the remote 147 may be affixed or attached to the device 100. An example embodiment of a wirelessly connected remote 147, having input receiving members 149, wherein the remote 147 is wirelessly connected to controller 145 on the device 100 is shown in FIG. 7.

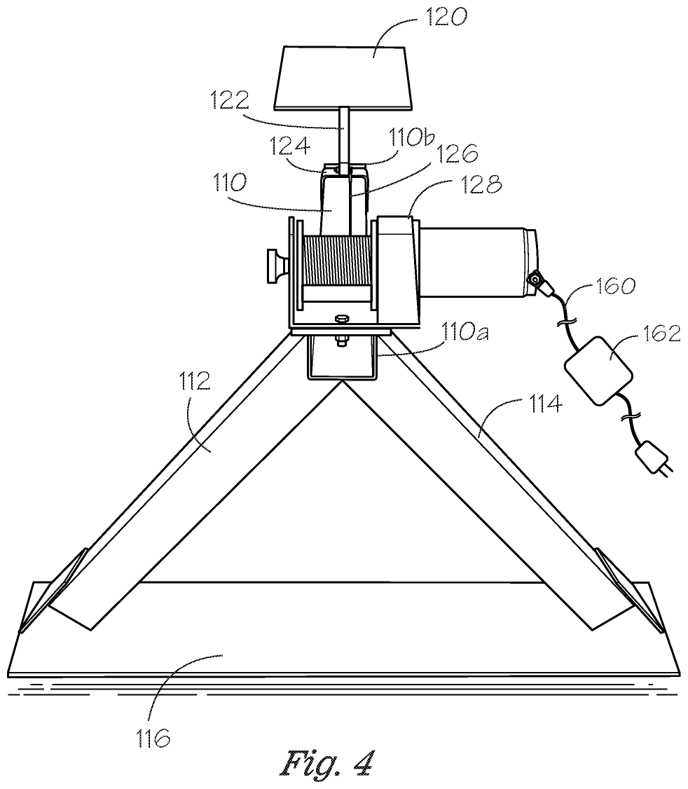

In other non-limiting embodiments, the device 100 may be powered by any means known to those skilled in the art to which the invention pertains. The platform lifting mechanism 128 may include, in some embodiments, a ball screw drive assembly including a drive motor with a ball screw drive, for example. In non-limiting embodiments, a chain, or other connection may extend from the ball screw drive assembly, and may be used to connect to the platform 120, directly or indirectly, to effectively lift and lower the platform 120. The device 100 may be connected to power accessories including optional accessories, the power accessories may include but are not limited to an electrical plug 160 (a 110 volt plug, in one non-limiting example), a battery 162, which in some instances may include a rechargeable battery, among other known components to power the device embodiments described herein. The device 100 in some embodiments, may include the electrical plug 160 to power the platform lifting mechanism 128. In other embodiments, the device 100 may be powered by way of a battery 162 (rechargeable or non-rechargeable battery). In other embodiments, the device 100 may be powered by both a battery 162 and an electrical plug 160, as shown in FIG. 4, for example.

In other alternative embodiments, the body 110 and/or the support members 112, 114 may be provided of square or round aluminum construction. These components may be hollow or solid in structure.

In some non-limiting embodiments as described herein, the platform 120 may be detachable from the device 100 and the platform 120 may be formed of a carbon fiber material, in a non-limiting embodiment.

The device 100 embodiments described herein may be used to lift a subject, injured or uninjured from the ground. The device 100 embodiments described herein are particularly useful for lifting a heavy-weight subject from the ground.

In some non-limiting embodiments, the device 100 may be configured to lift a subject bearing a weight of up to 1000 lbs. In yet another non-limiting embodiment, the device 100 may be configured to lift a subject bearing a weight of up to 5000 lbs.

For emergency services personnel, the device 100 may be maintained on an emergency services vehicle, and may be transported in a collapsed position as shown in the side view of an embodiment of the device 100 in FIG. 2, showing the first support member 112 and second support member 114 (second support member 114 not visible in the side view of FIG. 2) rotated in alongside the body 110 along its longitudinal axis to allow for alignment with the body 110 facilitating easier transportation of the device 100 by a user. Furthermore, in the collapsed position shown in FIG. 2, the device 100 can be easily placed onto, or removed from the emergency services vehicle, and easily transported into and out of doorways, through narrow hallways, and in smaller spaces before, during, and after use.

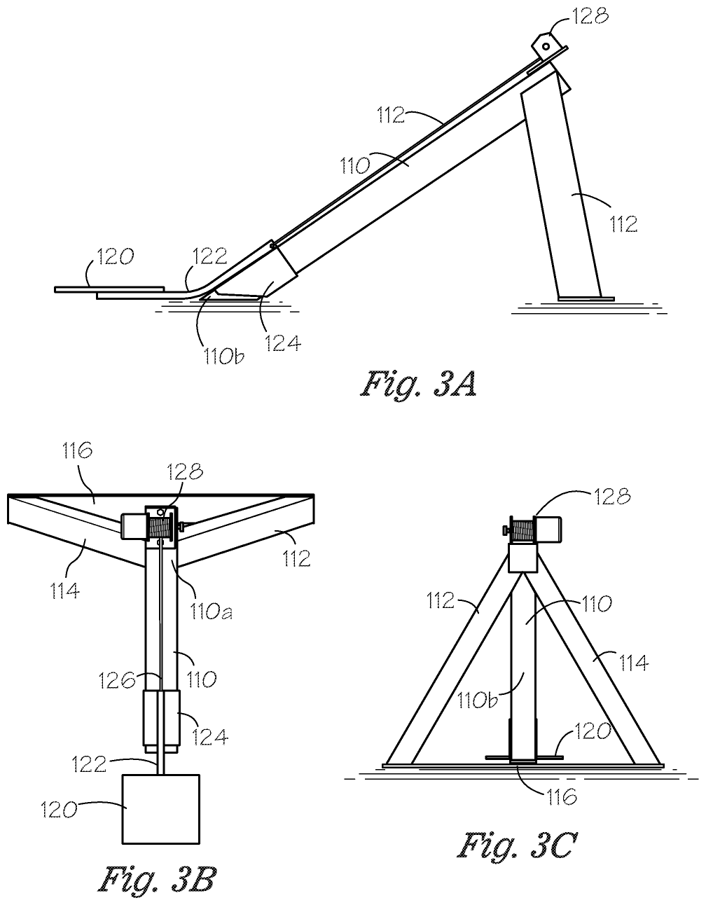

FIGS. 3A-C provide different views of an embodiment of the device 100 including a body 110 having a first end 110a and a second end 110b. The body second end 110b being configured to associate with a generally horizontal surface (i.e., a support surface), and the body first end 110a being configured to associate with at least a first support member 112 and a second support member 114. Additional support members may be provided to associate with body 110. The first and second support members 112, 114 support the body 110 at or near the first end 110a, in some embodiments, and extend to the generally horizontal surface. In some embodiments, a support base member 116 may be provided to associate with each of the support members 112, 114, and to extend between the support members 112, 114, disposed on the generally horizontal surface. The support base member 116 may provide additional stability to the device 100. The support base member 116 may take on many different shapes and sizes, with the overall function of providing additional support to the device via the support members 112, 114 and the body 110. In FIG. 3A, a side view of an embodiment of a lifting device 100 is shown. FIG. 3A shows the body 110 positioned between a generally horizontal support surface (i.e., a floor), and the first and second support members 112, 114, such that the body forms an angle between 20-80 degrees with the generally horizontal support surface. In other embodiments, the body may form an angle between 30-60 degrees with the generally horizontal support surface. In some embodiments, the first and second support members 112, 114 are movable to and away from the body 110, but are also rotatable relative to the body, to move parallel to the longitudinal axis of the body 110, in one example, and the first and second support members 112, 114 are movable and rotatable away from the longitudinal axis of the body 110 at an angle of between 5 degrees and 170 degrees from the angle of the body 110. The angular positions of the body 110 and the support members, relative to one another provide variability in the incline of the lift device 100 and vary the angle of the movement of the platform 120. Furthermore, the angular positioning of the support members 112, 114, relative to the body 110 is effective to provide support to the device 100 as a whole, in order to stabilize the device 100 to enable safely lifting of a heavy subject.

In FIG. 3B, a top view of the device 100 embodiment shown in FIG. 3A is provided, and in FIG. 3C, a rear view of the device 100 shown in FIG. 3A is provided.

FIG. 4 is a rear perspective view of a lifting device 100 as shown in FIG. 1, wherein the platform 120 is shown in a first position. The platform lifting mechanism 128 is shown with a cable 126 extending there from, and wind-able around a spool. The cable 126 connecting between the platform lifting mechanism 128 and the lifting arm 122. The lifting arm 122 is associated with the lifting arm bracket 124, slidably associated with the body 110, and disposed near the distal end 110b, thereof, while the platform 120 is in the first position. The first and second support members 112, 114, are shown permanently affixed to a support base member 116, which is optional, but is shown in FIG. 4, and may provide additional support to the device 10, in some embodiments. While the first and second support members 112, 114, are shown permanently affixed to the support base member 116, the may be removably attached to the support base member 116 or configured to associate with a generally horizontal surface on which the device 100 is placed, directly, in some embodiments. FIG. 4 shows a power source associated with the platform lifting mechanism 128 configured to power the mechanism 128. In FIG. 4, the power source includes an electrical plug 160, which may include a 110 outlet plug, and a battery 162, which may be rechargeable, in some embodiments. In other embodiments, as further described herein, the device 100 may be powered by other means known in the art, or by either one of the electrical plug or a battery.

FIG. 5 is a side view of the lifting device 100 having body 110 as provided in FIG. 1B, showing the platform 120 in the first position, and the lifting arm bracket 124 is positioned near the distal end of the body 110b. The platform 120 is provided, extending from lifting arm 122, the lifting arm 122 connected to cable 126, which is associated with platform lifting mechanism 128 to enable lifting and lowering of the platform 120. In the embodiment shown in FIG. 5, as shown in FIG. 1B, the lifting mechanism includes a winch powered by a motor 132, which includes a spool 130, for winding a cable 126, for lifting and lowering the platform 120.

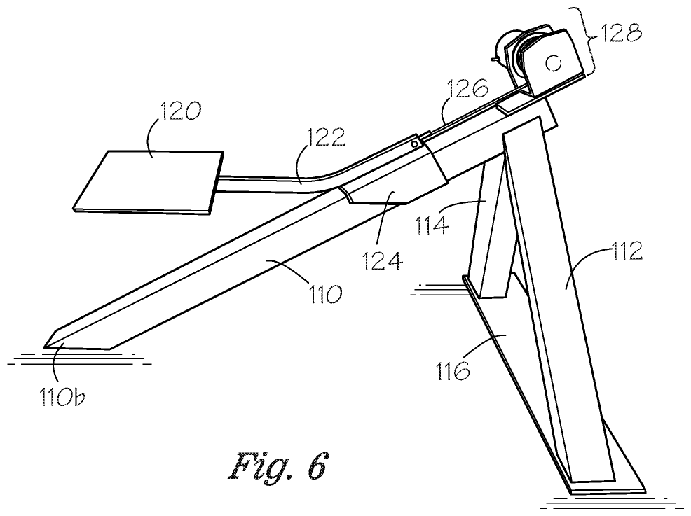

FIG. 6 is a side view of the lifting device embodiment 100 as shown in FIG. 1B, wherein the platform 120 has been raised from the first position by virtue of platform lifting mechanism 128. There are numerous possible positions for the platform between the first position shown in FIG. 5 and a second position. These positions between the first position and the second position are shown in FIGS. 6-7. Movement from the first position of the platform in FIG. 5 to an elevated, position of the platform 120 shown in FIGS. 6-7 occurs by operation of the platform lifting mechanism 128, wherein in one example is caused by the actuation of a winch causing the winding of the cable 126 to lift the platform 120 by way of the lifting arm and lifting arm bracket as shown in FIGS. 6-7.

FIG. 7 provides a front perspective view of the lifting device 100 as shown in FIG. 6, wherein the platform 120 has been elevated, and wherein the bracket is shown near a first end of the body 110a. When lifting a subject from the floor, the first position of the platform 12 as shown in FIG. 5 may be used for loading the subject onto the platform 120, and subsequent positions for the platform 120 as shown in FIGS. 6-7 may be used for lifting and unloading of the subject. Once the subject is loaded onto the platform 120 in its first position, the device 100 may be operated such that the platform lifting mechanism 128, for example, the winch, is actuated to cause a cable connected thereto to be retracted. Retraction of the cable 126 can occur, in one non-limiting embodiment, by rotation of the spool 130 as shown in FIGS. 5-7. Rotation of the spool 130 with the cable 126 wrapped around the spool and attached to the lifting arm or platform 120, will cause the platform 120 to be raised when the spool 130 is rotated in a first direction, and to be lowered when the spool 130 is rotated in a second direction.

In another embodiment, a portable lifting device including a platform lifting mechanism, a body extending between the platform lifting mechanism and a generally horizontal support surface, and a plurality of support members extending away from the body, configured to support the body at an angled position, the plurality of support members comprising at least a first support member and a second support member extending between the body and the generally horizontal support surface is provided. The portable lifting device may further include a power source, a removable platform, the platform being associated with and movable along the body between a first position and a second position, wherein the platform is configured to receive an object, and a connection mechanism for connecting the removable platform to the platform lifting mechanism, wherein the platform lifting mechanism is configured to raise or lower the platform between the first position and the second position.

In some embodiments, the device 100 may include one or more wheels associated with the body 110, or the first or second supporting members 112, 114, and/or the platform 120, 120′, to assist in moving the device 100 from location to location without lifting the device 100. It is important to an understanding of the present invention to note that all technical and scientific terms used herein, unless defined herein, are intended to have the same meaning as commonly understood by one of ordinary skill in the art. The techniques employed herein are also those that are known to one of ordinary skill in the art, unless stated otherwise. For purposes of more clearly facilitating an understanding the invention as disclosed and claimed herein, the following definitions are provided.

While a number of embodiments of the present invention have been shown and described herein in the present context, such embodiments are provided by way of example only, and not of limitation. Numerous variations, changes and substitutions will occur to those of skill in the art without materially departing from the invention herein. For example, the present invention need not be limited to best mode disclosed herein, since other applications can equally benefit from the teachings of the present invention. Also, in the claims, means-plus-function and step-plus-function clauses are intended to cover the structures and acts, respectively, described herein as performing the recited function and not only structural equivalents or act equivalents, but also equivalent structures or equivalent acts, respectively. Accordingly, all such modifications are intended to be included within the scope of this invention as defined in the following claims, in accordance with relevant law as to their interpretation. The teachings of all references cited herein are incorporated in their entirety to the extent not inconsistent with the teachings herein.

What is claimed is:

1. A lifting device, comprising:
a body;
at least a first support member and a second support member associated with the body;
a power source;
a platform movable relative to the body between a first position and a second position, wherein the lifting device is configured to receive an object on the platform, and to raise or lower the object between the first position and the second position; and
a platform lifting mechanism associated with the platform, configured to lift and lower the platform.

2. The lifting device of claim 1, wherein the platform lifting mechanism includes a spool and a cable wound thereon, the cable for connecting to the platform to raise the platform when the cable is wound around the spool, and to lower the platform when the cable is unwound from the spool.

3. The lifting device of claim 1, further comprising an intermediate component interfacing between the platform and the body, wherein the intermediate component moves relative to the body as the platform is raised and/or lowered.

4. The lifting device of claim 3, wherein the intermediate component comprises a bracket, the bracket being associated with the platform.

5. The lifting device of claim 4, wherein the bracket is slidable relative to the body to lift and/or lower the platform.

6. The lifting device of claim 3, further comprising a lifting arm for associating with the platform and the bracket.

7. The lifting device of claim 1, further comprising a support base member connecting between the first support member and the second support member when the device is in use.

8. The lifting device of claim 1, wherein a connecting mechanism connects between the first support member and the body and/or the second support member and the body, the connecting mechanisms(s) configured to allow folding of the first and/or second support members relative to the body, to align the support members align with the body along its longitudinal axis for transportation of the lifting device.

9. The lifting device of claim 1, wherein the platform lifting mechanism comprises a ball screw drive assembly.

10. The lifting device of claim 9, wherein the ball screw drive assembly includes a chain, said chain connecting between the ball screw drive assembly and the platform, such that actuation of the ball screw drive assembly raises or lowers the platform, or both.

11. The lifting device of claim 1, wherein each of the first support member and second support member extend away from the body at an angle between 10 degrees and 80 degrees from a plane in which the body is disposed.

12. The lifting device of claim 1, further comprising a controller to execute movement of the platform lifting mechanism.

13. The lifting device of claim 12, further comprising a remote, wherein the remote is wired to or wirelessly communicates with the controller to operate the controller.

14. The lifting device of claim 1, wherein the body is positioned between, at a first end, a generally horizontal support surface and, at a second end, a first and second support member, the body being angularly positioned, forming between a 20-80 degree angle with the generally horizontal support surface.

15. The lifting device of claim 1, wherein the body is positioned between, at a first end, a generally horizontal support surface and, at a second end, a first and second support member, the body being angularly positioned, forming between a 30-60 degree angle with the generally horizontal support surface.

16. The lifting device of claim 1, wherein the platform comprises a size and shape for receiving a subject.

17. The lifting device of claim 1, and wherein a plane of the platform maintains a generally horizontal position, the position being substantially parallel to a generally horizontal support surface upon which the device is provided, to maintain a subject thereon during operation of the device.

18. A portable lifting device, comprising:
a platform lifting mechanism;
a body extending between the platform lifting mechanism and a generally horizontal support surface;
a plurality of support members extending away from the body, configured to support the body at an angled position, the plurality of support members comprising at least a first support member and a second support member extending between the body and the generally horizontal support surface;
a power source;
a removable platform, the platform being associated with and movable along the body between a first position and a second position, wherein the platform is configured to receive an object;
a connection mechanism for connecting the removable platform to the platform lifting mechanism, wherein the platform lifting mechanism is configured to raise or lower the platform between the first position and the second position.

19. The portable lifting device of claim 18, further comprising a coupling between the body and each of the plurality of support members, such that the support members may be movable relative to the body to collapse the portable lifting device during transportation.
